(19) United States
(12) Patent Application Publication
(10) Pub. No.: US 2011/0027586 A1
(43) Pub. Date: Feb. 3, 2011

(54) ELECTRODE MEMBER FOR COLD CATHODE FLUORESCENT LAMP

(75) Inventors: Akihisa Hosoe, Osaka (JP); Shinji Inazawa, Osaka (JP); Kazuo Yamazaki, Osaka (JP); Takeshi Tokuda, Osaka (JP); Tetsuji Tominaga, Osaka (JP)

Correspondence Address: DRINKER BIDDLE & REATH (DC), 1500 K STREET, N.W., SUITE 1100, WASHINGTON, DC, 20005-1209, US

(73) Assignee: SUMITOMO ELECTRIC INDUSTRIES, LTD., Osaka-shi (JP)

(21) Appl. No.: 12/937,506

(22) PCT Filed: Apr. 17, 2008
(86) PCT No.: PCT/JP2008/001010

§ 371 Date: Oct. 12, 2010

(51) Int. Cl. B32B 17/06; B05D 5/12; C03C 27/02

(52) U.S. Cl. 428/389; 427/78; 65/59.1

(57) ABSTRACT

The invention offers an electrode member for a cold cathode fluorescent lamp, the member having excellent ability to attain intimate contact between the lead portion and glass, and a production method thereof. The electrode member 10 has an electrode portion 11, a lead portion 12, and a glass portion 13. The lead portion 12 is formed such that at least its surface side is composed of an iron-containing metal. The lead portion 12 has on its surface an oxide film 12s at the place covered by the glass portion 13. The oxide film 12s contains FeO. In comparison with an oxide film composed of Fe₂O₃ and Fe₃O₄, the oxide film 12s containing FeO tends to have great ability to attain intimate contact with glass. Consequently, the electrode member 10 can bring the lead portion 12 into sufficient intimate contact with the glass portion 13, enabling the constituting members from the lead portion 12 to the glass tube of the cold cathode fluorescent lamp to attain sufficient intimate contact between them.

### TECHNICAL FIELD

The present invention relates to an electrode member to be used as a constituting member for a cold cathode fluorescent lamp and a method of producing the electrode member. In particular, the present invention relates to an electrode member having excellent ability to attain intimate contact between the lead portion and the glass.

### BACKGROUND ART

Cold cathode fluorescent lamps have been used as various light sources such as a light source for illuminating a document in a copier, an image scanner, or the like and a light source for a backlight of a liquid crystal display device (a liquid crystal display), such as an LCD monitor of a personal computer and an LCD television. A cold cathode fluorescent lamp is typically provided with a circular glass tube having a layer of a fluorescent substance on its inner surface and a pair of electrodes placed at both ends of the glass tube. The glass tube has sealed-in rare gas and mercury (see, for example, Patent Literature 1).

The electrode is typically cup-shaped (a bottomed tubular shape). A lead wire is bonded to its bottom portion, and a voltage is applied to the electrode through the lead wire. The lead wire is provided, for example, with an inner lead wire fixed in the glass tube and an outer lead wire that is bonded with the inner lead wire and placed at the outside of the glass tube. A typical constituting material of the inner lead wire is Kovar (alloy of Fe, Co, and Ni) having a coefficient of thermal expansion close to that of glass. In a fluorescent lamp required to have long life and high quality, to facilitate the attaining of intimate contact between the inner lead wire and the glass tube, it is usually performed that a glass bead is fixed to the periphery of the inner lead wire and then the glass bead and the glass tube are melted. The electrode, lead wire, and glass bead are unified by bonding in advance, and subsequently the unified body is fixed to the glass tube.

To increase the ability to attain intimate contact between the inner lead wire and the glass bead, before the glass bead is bonded with the inner lead wire, the formation of an oxide film on the periphery of the inner lead wire is being practiced (see Patent Literature 1).

Patent Literature 1: the published Japanese patent application Tokukaihei 11-238489.

### SUMMARY OF INVENTION

### Technical Problem

Despite the above description, the conventional cold cathode fluorescent lamp is insufficient in attaining intimate contact between the lead wire and the glass even when an oxide film is formed on the lead wire.

Patent Literature 1 has described that the formation of an oxide film on the lead wire increases the wettability of the glass bead with the lead wire, thereby enabling the increase in the airtightness of the glass tube. Nevertheless, it cannot be said that the conventional oxide film sufficiently attains intimate contact with the glass bead. Consequently, it is desired to further increase the bonding strength. When the lead wire is insufficient in intimate contact with the glass bead, the constituting members from the lead wire to the glass tube cannot be brought into intimate contact between them, so that the sealing portion of the glass tube forms gaps. The gas in the glass tube may leak through the gaps. When the gas leaks, for example, ultraviolet rays necessary to emit light are not sufficiently radiated, so that the life of the fluorescent lamp is shortened.

In view of the above circumstances, a main object of the present invention is to offer an electrode member that can increase the bonding strength between the lead portion and the glass. Another object of the present invention is to offer a method suitable for producing the electrode member.

### Solution to Problem

The oxide film can be formed by heating the lead wire in an atmosphere containing oxygen such as an air atmosphere. For example, when an oxide film is formed by heating a lead wire made of Kovar in the air, the oxide film is composed of iron oxide having a high content of oxygen, specifically ferric oxide (Fe₂O₃) and ferrous ferric oxide (Fe₃O₄). The oxide film composed of the above-described iron oxide sometimes cannot attain sufficient intimate contact with the glass bead or the glass tube. To increase the ability to attain intimate contact, it is conceivable, for example, to increase the thickness of the oxide film. If the oxide film is thick, however, the oxide film itself becomes brittle and tends to peel. In addition, because the difference in coefficient of thermal expansion between the oxide film and the glass is relatively large, if the oxide film is thick, an oxide film having a large amount of thermal expansion and contraction is sandwiched between the glass and the lead wire. Furthermore, the oxide film formed on the lead portion has a large number of pores. The number of pores is decreased by the heating at the time the glass bead is bonded to the lead portion or at the time the glass tube is sealed by the electrode member. Nevertheless, if the oxide film is thick, a large number of pores remain in the film. The remaining pores may cause the gas in the glass tube to leak.

Considering the above circumstances, the present inventers have studied to find a structure that can improve the bonding strength without increasing the thickness of the oxide film. They have found that it is desirable to employ an oxide film that contains a specific compound. More specifically, the finding shows that an oxide film containing FeO has a higher bonding strength than that of the oxide film composed of Fe₂O₃ and Fe₃O₄. Although the reason for this is uncertain, the likely reason is that the oxide film containing FeO has an increased wettability with the glass. Based on this finding, the electrode member of the present invention is specified to have a structure that is provided with an oxide film containing FeO. More specifically, the electrode member of the present invention for a cold cathode fluorescent lamp has an electrode portion and a lead portion. The lead portion is connected to an end portion of the electrode portion. In addition, the lead portion is formed such that at least its surface side is composed of an iron-containing metal. The above-described lead portion has an oxide film, which contains FeO, on at least one part of its surface.

Being provided with the foregoing oxide film, the electrode member of the present invention can bring the lead portion into sufficient intimate contact with the glass. Consequently, when the electrode member of the present invention is placed in the glass tube and the opening of the glass tube is sealed, the constituting members from the lead portion to the glass tube can be brought into sufficient intimate contact between them. Therefore, when a cold cathode fluorescent lamp is formed using the electrode member of the present invention, the fluorescent lamp can suppress the gas from leaking through the sealing portion of the glass tube. As a result, a sufficient amount of gas (particularly mercury) remains in the glass tube, thereby prolonging the life of the fluorescent lamp. Furthermore, having a sufficient amount of gas (particularly mercury), the lamp can not only maintain the high luminance but also suppress the shortening of the life owing to a decrease in luminance.

The electrode member of the present invention can be produced through the production method of the present invention described below. The method of the present invention for producing an electrode member for a cold cathode fluorescent lamp is a method of producing an electrode member having a lead portion at an end portion of an electrode portion. The method has the following oxide-film-forming step.

### Oxide-Film-Forming Step

This step forms an oxide film on the surface of the lead portion by heating the periphery of the lead portion. The lead portion is specified to be formed such that at least its surface side is composed of an iron-containing metal. This step has the following two steps in which the atmosphere is different from each other.

Oxidizing Step

This step forms the oxide film by heating the lead portion in an oxidizing atmosphere.

Nonoxidizing Step

After the oxidizing step, this step forms FeO in the oxide film by heating the lead portion in a nonoxidizing atmosphere.

The above-described production method of the present invention can easily produce the electrode member of the present invention provided with an oxide layer containing FeO by heating the lead portion in different atmospheres. The present invention is explained below in further detail.

The electrode member of the present invention is used as a constituting material for a cold cathode fluorescent lamp and provided with an electrode portion to be used for the electrical discharge and a lead portion for supplying electric power to the electrode portion. In particular, it is desirable that the electrode member, which is to be used in a cold cathode fluorescent lamp required to have long life and high quality, be provided not only with the foregoing electrode portion and lead portion but also with a glass portion that functions as the bonding agent at the time the electrode portion is fixed to the glass tube of the fluorescent lamp and that also acts as the sealing member of the glass tube at the same time.

The lead portion can be provided, for example, with an inner lead portion and an outer lead portion. The inner lead portion is bonded, at its one end, with the electrode portion and fixed to the inside of the glass tube. The outer lead portion is bonded with the inner lead portion and exposed to the outside of the glass tube. The outer and inner lead portions are bonded together by welding or the like. When a weld hump is provided at the bonded portion, the weld hump can be used as a stopper for a glass bead described later to prevent the misalignment of the glass portion.

The outer lead portion can be formed by using, for example, a wire made of nickel (Ni), a wire made of nickel alloy such as MnNi, or a wire made of dumet. These wires may be provided with a plated layer such as a nickel-plated layer.

The inner lead portion is bonded, at its periphery, with glass such as a glass tube or a glass portion formed of a glass bead. Therefore, it is desirable that the inner lead portion be formed by using a wire made of a material having a coefficient of thermal expansion close to that of glass. In addition, it is desirable that the inner lead portion be formed by using a wire made of a material having high conductivity. An example of the material that satisfies the above-described property is a metal containing iron (Fe). In particular, the electrode member of the present invention has an inner lead portion produced by using a wire that is formed such that at least its surface side is composed of an iron-containing metal. For example, the following wires can be used: a wire composed of an alloy known as Kovar, which is produced by adding Co and Ni to Fe (the alloy also contains Si, Mn, and the like) and a wire having a core member made of copper (Cu) and a Kovar layer provided on the periphery of the core member. The inner lead portion is provided with an oxide film on at least one part of its surface in advance. More specifically, on the surface of the inner lead portion, an oxide film is formed at the place where the inner lead portion is covered with a glass tube or glass portion. Consequently, when the electrode member of the present invention is provided with a glass portion bonded with the periphery of the lead portion, the electrode member has an oxide film in the vicinity of the boundary between the glass portion and the inner lead portion.

The oxide film is composed of the oxide formed by the oxidation of the constituting elements of the lead portion. When the inner lead portion is formed such that at least its surface side is composed of an iron-containing metal, the oxide film is composed practically of iron oxide. In particular, when the oxide film is formed in an oxidizing atmosphere such as in the air, the oxide film is composed of ferric oxide (Fe₂O₃) and ferrous ferric oxide (Fe₃O₄). In the electrode member of the present invention, the oxide film is formed under a specific condition described below. Consequently, the electrode member is provided with an oxide film containing ferrous oxide (FeO) in addition to Fe₂O₃ and Fe₃O₄. In comparison with the oxide film composed of Fe₂O₃ and Fe₃O₄, the oxide film containing FeO has a tendency to have excellent ability to attain intimate contact with glass, and as the content of FeO is increased, the ability to attain intimate contact tends to increase. In particular, without regard to the presence or absence of the glass portion, when the total volume of the oxide film formed on the electrode member is taken as 100%, it is desirable that the content of FeO be 1% or more in volume ratio, more desirably 10% or more.

The oxide film formed on the lead portion varies in the proportion of the constituting compounds by the heating at the time the glass portion is bonded to the lead portion and at the time the electrode member is fixed to the glass tube. More specifically, the FeO content tends to decrease by the above-described heating. Considering this tendency, when the electrode member is designed to have a glass portion, an oxide film is formed on the lead portion such that before the lead portion is provided with the glass portion, the oxide film has an FeO content of more than 1 vol. % so that after the electrode member is provided with the glass portion, the oxide film can have an FeO content of 1% or more in volume ratio. Yet more specifically, the oxide film is formed on the lead portion so as to have an FeO content of 10% or more in volume ratio, desirably 50% or more. The presence or absence of FeO in the oxide film and the volume ratio of the types of oxides included in the entire film can be measured, for example, through X-ray diffraction.

Without regard to the presence or absence of the glass portion, it is desirable that the oxide film of the electrode member have a thickness of 1 μm or more and less than 10 μm, more desirably 1 μm or more and 7 μm or less. If the oxide film of the electrode member has a thickness of less than 1 μm, because the heating at the time the electrode member is fixed to the glass tube tends to decrease the thickness of the oxide film, the oxide film may disappear. If the oxide film disappears, the constituting elements of the lead portion are easily diffused into the glass side, so that the thickness of an ion-diffused layer described later is likely to increase. If the oxide film has a thickness of more than 10 μm, even when the heating is performed to fix the electrode member to the glass tube, a large number of pores may remain in the oxide film. The thickness of the oxide film can be adjusted in accordance with the size (diameter) of the lead portion and the size (inner diameter) of the glass tube. When the lead portion has a diameter of 0.4 to 1.2 mm or so, it is desirable that the oxide film of the electrode member have a thickness in the above-described range. When the lead portion has a diameter larger than the foregoing value, the oxide film may have a thickness thicker than the above-described range.

However, when the electrode member is designed to have a glass portion, elements constituting the oxide film formed on the lead portion are diffused into the glass side by the heating at the time of the bonding of the glass portion, thereby decreasing the thickness of the oxide film. Considering this phenomenon, in order that the oxide film of the electrode member can have a thickness in the foregoing range (1 to 10 μm) after the formation of the glass portion, the oxide film is formed on the lead portion before the formation of the glass portion with a thickness thicker than the foregoing range. More specifically, it is desirable that the thickness be 6 to 20 μm or so. The thickness of the oxide film before the formation of the glass portion can be adjusted as appropriate providing that the thickness of the oxide film after the formation of the glass portion satisfies the foregoing range.

The oxide film containing FeO can be formed by two stages of heating. The first stage of heating is performed in an oxidizing atmosphere (an oxidizing step) to bond oxygen (O) with an element (Fe) included in the lead portion, so that Fe₂O₃ and Fe₃O₄ are formed. The heating can be performed by using a burner or an electric furnace. A burner is easy to adjust the combustion gas. By properly adjusting the combustion gas, an oxide film having a desired thickness can be formed stably. An electric furnace can form the oxide film on a large number of lead portions simultaneously. Consequently, the use of an electric furnace attains excellent mass-producibility. When an electrode member provided with a glass portion is employed, a burner is used at a heating temperature of 900° C. to 1,200° C. and a heating period of 3 to 12 seconds, for example, and an electric furnace is used at a heating temperature of 650° C. to 1,000° C. and a heating period of 2 to 8 minutes, for example. As the heating temperature is increased or the heating period is prolonged, the oxide film tends to be thickened. It is more desirable to use a burner at a heating temperature of 950° C. to 1,150° C. and a heating period of 3 to 8 seconds and to use an electric furnace at a heating temperature of 700° C. to 850° C. and a heating period of 3 to 5 minutes. When an electrode member provided with no glass portion is employed, it is desirable to shorten the above-described heating period. The oxidizing atmosphere is required only to contain oxygen. An example of this type of atmosphere is an air atmosphere. The oxidizing step employs heating in an oxidizing atmosphere. Therefore, oxygen (O) bonds with iron (Fe), which is included in the constituting materials of the inner lead portion, to produce Fe₂O₃ and Fe₃O₄, which are iron oxides having a quantity of bonded oxygen, without producing FeO.

The second stage of heating is performed in a nonoxidizing atmosphere (a nonoxidizing step). When heating is performed in an atmosphere containing virtually no oxygen, Fe, which is one of the constituting elements of the lead portion, is diffused into the oxide film formed in the first stage of heating (the oxidizing step), practically without increasing the thickness of the oxide film. This diffusion increases the atomic ratio of Fe in the oxide film, enabling the formation of FeO in the film. Because this heating is performed in a nonoxidizing atmosphere, it is desirable to use an electric furnace. In addition, it is essential only that this heating be performed to the extent necessary to change the compounds constituting the oxide film. More specifically, this heating can be performed at a temperature of 900° C. to 1,100° C. for 3 to 5 minutes. It is more desirable to perform this heating at a temperature of 950° C. to 1,050° C. for 3.5 to 4.5 minutes. The nonoxidizing atmosphere is required only not to contain oxygen practically. An example of this type of atmosphere is an inert atmosphere composed of inert gas such as nitrogen (N₂), argon (Ar), or helium (He). A reducing atmosphere may also be used that is produced by adding a reducing gas such as hydrogen to the foregoing inert gas. As described above, because this heating almost does not vary the thickness of the oxide film, an oxide film having a nearly desired thickness is formed in the first stage of heating.

The electrode portion may be formed by using a material such as nickel (pure Ni), tungsten (W), or molybdenum (Mo). Pure Ni is excellent in processibility and economical efficiency. W and Mo have a significantly high melting point in comparison with pure Ni, so that the consumption of the electrode portion and the decrease in luminance can be reduced. In addition, as the electrode portion-forming material, an Ni alloy may be used that is formed by adding an alloying element to pure Ni. An example of this alloy is an Ni alloy containing at least one element selected from the group consisting of Ti, Hf, Zr, V, Fe, Nb, Mo, Mn, W, Sr, Ba, B, Th, Be, Si, Al, Y, and rare earth elements (except Y) with a content of 0.001 mass % or more and 5.0 mass % or less in total with the remainder composed of Ni and unavoidable impurities. In particular, an Ni alloy may be used that contains at least one element selected from the group consisting of Be, Si, Al, Y, and rare earth elements (except Y) with a content of 0.001 mass % or more and 3.0 mass % or less in total with the remainder composed of Ni and unavoidable impurities. An electrode portion composed of the above-described Ni alloy has the following various advantages:
1. the electrode portion is easy to perform electrical discharge because it has a work function smaller than that of an electrode composed of pure Ni,
2. the electrode portion is less likely to create sputtering (the sputtering rate or etching rate is small),
3. the electrode portion is less prone to form an amalgam, and
4. the electrode portion is resistant to the formation of an oxide film, so that the discharge has little tendency to be impeded.
   In particular, an Ni alloy containing Y has an increased resistance to sputtering.

The electrode portion is typically cup-shaped (a bottomed tubular shape). The cup-shaped electrode portion can be easily formed by performing press working on a sheet material. The cup-shaped electrode portion can suppress the sputtering by virtue of the hollow-cathode effect.

When an electrode member provided with a glass portion is employed, the glass portion is formed by, first, slipping a tubular glass bead over the periphery of the lead portion (the inner lead portion) on which the above-described oxide film is formed and, then, heating the glass bead to deform it. At the same time, this heating bonds the glass portion to the periphery of the inner lead portion. It is possible to use a glass bead composed, for example, of borosilicate glass or aluminosilicate glass.

The heating to form the glass portion also heats the lead portion and diffuses elements constituting the lead portion and oxide film into the glass side to form an ion-diffused layer in the glass portion, particularly at its side brought into contact with the oxide film (in the ion-diffused layer, the constituents of the glass portion and lead portion are mixed). Because the ion-diffused layer has a coefficient of thermal expansion different from that of the other portion of the glass portion, if it is excessively thick, it causes breakage of the glass portion and the glass tube (in the vicinity of the sealed portion). In addition, the heating to seal the glass tube also forms an ion-diffused layer or increases the thickness of the existing ion-diffused layer. Consequently, it is desirable that the ion-diffused layer in the electrode member have the thinnest possible thickness. More specifically, it is desirable that the thickness be 15 μm or less, particularly 12 μm or less.

It is desirable that the glass portion be formed by using a burner or an electric furnace. When this heating technique is employed, the following method can be implemented. For example, the heating of the glass bead in a reducing atmosphere to perform the deformation and bonding is exploited to concurrently reduce (in a chemical sense) the oxide film at the portion uncovered by the glass portion in the lead portion (the oxide film at the exposed portion). To increase the bonding strength between the lead portion and the glass portion, it is effective to increase the wettability of the glass portion with the oxide film by sufficiently melting the glass portion at an increased heating temperature or with a prolonged heating period. When the heating temperature is raised or the heating period is prolonged, however, the glass bead deforms such that it extends along the oxide film on the lead portion, making it difficult to obtain the desired shape. In contrast, if the heating temperature is lowered or the heating period is shortened, although the glass bead can be easily deformed to the desired shape, sufficient bonding cannot be achieved. To solve this problem, it is desirable to employ two stages of heating described below, rather than performing the deformation and bonding in one stage of heating. When the two-stage heating is employed, not only can the glass bead be deformed to the desired shape but also the glass bead can be sufficiently bonded to the lead portion, with the ion-diffused layer being prevented from thickening.

More specifically, it is suitable to perform a glass-portion-forming step having a deformation step and a bonding step described below.

### Glass-Portion-Forming Step

First, a glass bead is placed on the periphery of a lead portion on which an oxide film is formed. Then, the glass bead is heated and deformed to form a glass portion and to bond the glass portion to the lead portion.

Deformation Step

This step is performed at a heating temperature of 700° C. to 800° C. for 3 to 5 minutes in a nonoxidizing atmosphere.

Bonding Step

This step is performed at a heating temperature of 900° C. to 1,100° C. for 3 to 5 minutes in a reducing atmosphere.

The deformation step is a heating step mainly performing the deformation of the glass bead. An example of the nonoxidizing atmosphere is an inert atmosphere composed of inert gas such as nitrogen, argon, or helium. Because a nonoxidizing atmosphere is employed, it is desirable to perform this heating by using an electric furnace. An electric furnace can deform a large number of glass beads simultaneously. Consequently, the use of an electric furnace attains excellent mass-producibility. A more desirable condition is a heating temperature of 750° C. to 800° C. and a heating period of 3.5 to 4 minutes. Because the deformation step is performed at a relatively low temperature, almost no ion-diffused layer is formed.

The bonding step is a heating step mainly bonding the deformed glass bead to the lead portion. An example of the reducing atmosphere is an atmosphere composed of a mixed gas of an inert gas, such as nitrogen, argon, or helium, and a reducing gas, such as hydrogen. When the heating is performed by using an electric furnace, this step can be performed in succession to the foregoing deformation step. A more desirable condition is a heating temperature of 950° C. to 1,000° C. and a heating period of 3.5 to 4 minutes. Because the bonding step is performed in a reducing atmosphere, the heating can be performed by using a burner. In this case, a desirable condition is a heating temperature of 1,000° C. to 1,200° C. and a heating period of 5 to 10 seconds. In this bonding step, although an ion-diffused layer is formed, the thickness of the ion-diffused layer can be limited to 15 μm or less by performing the heating under the above-described condition. In addition, the heating can decrease the number of pores in the oxide film. Furthermore, the heating can reduce (in a chemical sense) and remove the oxide film at the portion uncovered by the glass portion in the lead portion.

The above-described electrode member of the present invention having a lead portion, an electrode portion, and, as required, a glass portion can be suitably used as a constituting member of a cold cathode fluorescent lamp. For example, a cold cathode fluorescent lamp can be formed by using a glass tube having two openings and electrode members of the present invention and through the procedure described below. A glass tube is prepared that has a layer of fluorescent substance on its inner surface. An electrode member is inserted into one of the openings of the glass tube. The lead portion (the glass portion) is placed in the vicinity of the opening. The glass tube's portion brought into contact with the lead portion is heated. When the electrode member has a glass portion, both the glass tube's portion brought into contact with the glass portion and the glass portion are heated. The heating melts the glass, so that the opening is sealed and the electrode member is fixed. The glass tube is evacuated in vacuum from the other opening. A specified gas is introduced into the glass tube. Another electrode member is inserted into this opening, and the lead portion (the glass portion) is placed in the vicinity of this opening. The glass tube's portion brought into contact with the lead portion is heated. When the electrode member has a glass portion, both the glass tube's portion brought into contact with the glass portion and the glass portion are heated. The heating melts the glass, so that the glass tube is sealed and the electrode member is fixed to the glass tube. Through the above steps, a cold cathode fluorescent lamp is obtained. A typical glass tube is I-shaped and has two openings. The other types of glass tube include an L-shaped glass tube having two or three openings and a T-shaped glass tube having three openings.

### ADVANTAGEOUS EFFECT OF INVENTION

The electrode member of the present invention for a cold cathode fluorescent lamp can attain sufficient intimate contact between the lead portion and the glass. Consequently, when a cold cathode fluorescent lamp is formed using the electrode member of the present invention, the constituting members from the lead wire to the glass tube can be brought into sufficient intimate contact between them, so that gas leakage through the sealing portion of the glass tube can be prevented. As a result, the electrode member of the present invention shows promise for contributing to the prolongation of the life of the fluorescent lamp.

### BRIEF DESCRIPTION OF DRAWINGS

FIG. 1 is a partial cross-sectional view schematically showing the structure of an electrode member.

FIG. 2 is an illustration explaining a bonding strength test.

### REFERENCE SIGNS LIST

10: Electrode member; 11: Electrode portion; 12: Lead portion; 12i: Inner lead portion; 12o: Outer lead portion; 12s: Oxide film; 13: Glass portion; 100: Alternative member; 120: Inner lead portion; 130: Glass portion; and 200: Jig.

### DESCRIPTION OF EMBODIMENTS

Electrode members having different compounds for forming the oxide film were produced to examine the bonding strength.

### Electrode Member

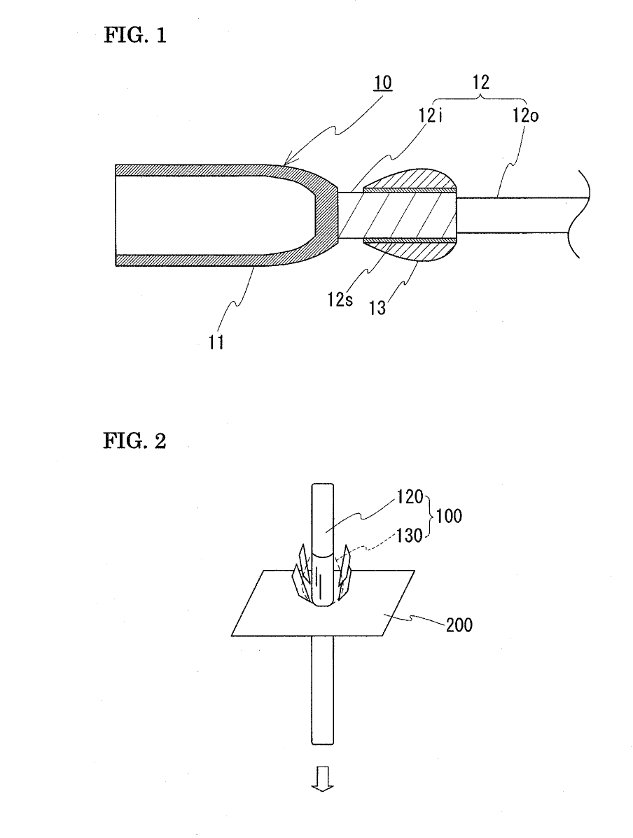

FIG. 1 is a partial cross-sectional view schematically showing the structure of an electrode member. All of the produced electrode members have the same structure as that of an electrode member 10 shown in FIG. 1. The electrode member 10 is provided with a cup-shaped electrode portion 11, a lead portion 12 that is bonded to the bottom portion of the electrode portion 11, and a glass portion 13 that is bonded to the periphery of the lead portion 12. The lead portion 12 is composed of an inner lead portion 12i that is bonded to the glass tube of a cold cathode fluorescent lamp and an outer lead portion 12o that is placed so as to be exposed to the outside of the tube. The inner lead portion 12i is provided on its surface with an oxide film 12s at the place to be covered by the glass portion 13. The foregoing electrode member was produced as described below.

### Example

### 1. Formation of the Electrode Portion and Lead Portion

The electrode portion 11 was formed in the shape of a cup by performing press working on a nickel sheet. The lead portion 12 was formed by welding one end face of a wire (diameter: 0.8 mm) composed of Kovar (Ni: 28 to 30 mass %; Co: 16 to 18 mass %; and the remainder: Fe) with one end face of a wire composed of nickel alloy (MnNi). The Kovar-wire portion forms the inner lead portion 12i, and the nickel alloy-wire portion forms the outer lead portion 12o. A weld hump (not shown) was formed at the bonded portion between the two wires. The obtained lead portion 12 was subjected to surface finishing such as barrel polishing and chemical polishing. A plurality of lead portions were prepared that had the above-described structure.

### 2. Formation of an Oxide Film

The periphery of the inner lead portion 12i (the periphery of the portion at the inner lead portion side away from the weld hump) was heated to form the oxide film 12s on the surface of the inner lead portion 12i. The heating was conducted in two stages as described below.

(1) Oxidizing Step

The heating was conducted at a temperature of 800° C. for four minutes in an air atmosphere by using an electric furnace.

(2) Nonoxidizing Step

Subsequently, the heating was conducted at a temperature of 980° C. for four minutes in a nitrogen atmosphere by using an electric furnace, and then cooling was performed.

After the cooling, an examination was carried out to obtain the proportion (volume ratio) of the compounds constituting the oxide film formed on the lead portion. The measurement was performed through X-ray diffraction. The result showed that in every lead portion, FeO was detected and the volume ratio of FeO was 90% and the remainder was Fe₃O₄ and Fe₂O₃.

An examination showed that the oxide film formed on the lead portion had a thickness of 2.8 to 3.7 μm. The thickness of the oxide film was measured using a microscope photograph. Furthermore, the state of the oxide film was observed under a microscope. The result revealed that a large number of pores were present.

Next, a glass bead was slipped over the periphery of the inner lead portion 12i on which the above-described oxide film was formed. The glass bead is composed of borosilicate glass (BFK) consisting mainly of SiO₂ and containing Na₂O and the like. The glass bead has the shape of a hollow circular cylinder whose end faces have an opening of a through hole. The through hole has a diameter slightly larger than that of the inner lead portion 12i. Consequently, when the glass bead is slipped over the inner lead portion 12i, a clearance is formed between the inner circumferential face of the glass bead and the outer circumferential face of the inner lead portion 12i. When the glass bead is slipped over the inner lead portion 12i, its position is easily determined at a predetermined place in the longitudinal direction of the inner lead portion 12i by virtue of the presence of the weld hump.

### 3. Bonding of the Electrode Portion

The bottom face of the cup-shaped electrode portion 11 was bonded with the other end face of the inner lead portion 12i (the face at the side where no weld hump was formed) through laser welding. By bonding the electrode portion 11 with the lead portion 12 before the glass bead melts (before the formation of the glass portion), the constituting elements of the oxide film can be suppressed from being diffused into the glass side owing to the heating of the inner lead portion 12i by the heat at the time of the bonding of the electrode portion. Despite the above description, the bonding of the electrode portion may also be performed after the melting of the glass bead described below.

### 4. Formation of the Glass Portion

### (1) Deformation Step

The lead portion 12 bonded with the electrode portion 11 and combined with the glass bead was placed in an electric furnace. Under this condition, heating was conducted at a temperature of 800° C. for four minutes in a nitrogen atmosphere to deform the glass bead, so that the glass bead was brought into contact with the oxide film. More specifically, the heating deformed the glass bead such that its corner portion was rounded and it was shrunk, so that the inner circumferential face of the through hole was brought into contact with the oxide film. This deformation transformed the glass bead into the glass portion 13.

### (2) Bonding Step

A hydrogen gas was additionally introduced into the electric furnace to produce an atmosphere composed of nitrogen and hydrogen (the proportion of the hydrogen: 16 vol. %). In this reducing atmosphere, heating was conducted at a temperature of 980° C. for four minutes to bring the glass portion 13 into intimate contact with the oxide film 12s. In other words, part of the oxide film 12s was diffused into the glass portion 13. In addition, during this heating, on the inner lead portion 12i, the exposed portion of the oxide film without being covered by the glass portion 13 was reduced (in a chemical sense) to be removed.

Through the steps 1 to 4 described above, the electrode member having the electrode portion, lead portion, and glass portion was obtained. A plurality of electrode members having the above-described structure were produced, and they are referred to as Example. Example was subjected to an examination to obtain the proportion of the compounds constituting the oxide film through X-ray diffraction. The result showed that every electrode member contained 1% or more FeO in volume ratio with the remainder being Fe₃O₄ and Fe₂O₃.

In addition, Example was subjected to measurement of the thickness of the oxide film using a microscope photograph. The result showed that the thickness was 1.4 to 2.5 μm, revealing that the thickness was decreased from the thickness at the time the oxide film was formed on the lead portion. The state of the oxide film of Example was observed under a microscope. The result revealed that the number of pores was decreased.

Example was also subjected to measurement of the thickness of the ion-diffused layer using a microscope photograph. The thickness was 6.2 to 7.2 μm, which is less than 15 μm and extremely thin.

### Comparative Example

An electrode member was produced by forming the oxide film under conditions different from those used in Example. In this electrode member, the oxide film was formed through one stage of heating instead of two stages of heating. More specifically, the heating was conducted at a temperature of 800° C. for four minutes in an air atmosphere by using an electric furnace. A plurality of electrode members were produced through the same steps as used in Example described above, except the step of forming the oxide film. These electrode members are referred to as Comparative example.

After the formation of the glass portion, Comparative example was subjected to an examination to obtain the proportion of the compounds constituting the oxide film through X-ray diffraction. The result showed that in every electrode member, no FeO was detected with the detection of only Fe₃O₄ and Fe₂O₃. In Comparative example, the oxide film had a thickness of 3 to 5 μm and the ion-diffused layer had a thickness of 6 to 7 μm, which is less than 15 μm.

### Reference Example

An electrode member was produced that had an inner lead portion made of tungsten (W) and that was provided with the glass portion. The glass portion and the glass tube used in Reference example were designed to have a coefficient of thermal expansion close to that of tungsten, A plurality of electrode members having the above-described structure were produced, and they are referred to as Reference example.

### Bonding Strength Test

Example, Comparative example, and Reference example were subjected to an examination of the bonding strength between the glass and the lead portion as described below. An electrode member was fixed to a jig 200, which is provided, as shown in FIG. 2, with a through hole having a size that allows the lead portion to pass through but rejects the glass portion to pass through. When the outer lead portion was pulled by applying a load, the force (N) at which the glass portion broke was examined to obtain the bonding strength. In Example, before the glass portion broke, the outer lead portion broke. To avoid this situation, an alternative member 100, in which a glass portion 130 was formed on an inner lead portion 120 without using an outer lead portion, was produced under the same condition as above. By using the alternative member 100, the bonding strength was examined. The results are shown in Table I.

TABLE I

| | | Comparative | Reference |
|---|---|---|---|
| | Example | example | example |
| n = 1 | 230.5 | 112.0 | 186.0 |
| n = 2 | 233.5 | 113.4 | 147.0 |
| n = 3 | 233.8 | 121.5 | 203.0 |
| n = 4 | 232.6 | 115.6 | 220.0 |
| n = 5 | 238.6 | 126.3 | 185.0 |
| ave | 233.8 | 117.8 | 188.2 |
| max | 238.6 | 126.3 | 220.0 |
| min | 230.5 | 112.0 | 147.0 |
| r | 8.1 | 14.3 | 73.0 |
| (max-min) | | | |
| σ | 3.0 | 6.0 | 27.1 |

As can be seen from Table I, Example has excellent bonding strength between the glass and the lead portion. Consequently, when a cold cathode fluorescent lamp is formed using the foregoing electrode member, it can be expected that the constituting members from the lead portion to the glass tube can be brought into sufficient intimate contact between them, so that gas leakage through the sealing portion of the glass tube can be prevented.

### Bending Test

Example and Comparative example underwent a bending operation at the inner lead portion to examine the state of breaking in the glass portion. The result showed that Comparative example broke such that broken pieces of the glass portion fell off the lead portion. In contrast, Example did not break in such a way that the glass portion was detached from the lead portion and its broken pieces fell off. Instead, the glass portion remained on the lead portion while maintaining its shape, with a large number of cracks developing in the radial direction of the glass portion. The result proves that in Example, the glass portion is brought into intimate contact uniformly with the periphery of the lead portion.

### Endurance Test

Cold cathode fluorescent lamps were produced using the electrode members of Example and Comparative example to carry out an endurance test. The cold cathode fluorescent lamp was produced using an I-shaped glass tube having two openings. An electrode member of Example was placed at each opening and the glass was heated, so that the opening was sealed and the lead portion was fixed. Thus, the lamp of Example was produced. On the inner surface of glass tube, a layer of halophosphate was formed in advance as the layer of fluorescent substance. When one of the openings was sealed, after the glass tube was evacuated in vacuum, a mixed gas of mercury and argon was introduced into the glass tube. The lamp of Comparative example was produced by using the electrode member of Comparative example through the same manner as above.

The obtained lamps of Example and Comparative example were subjected to an endurance test. Generally, the luminance of a cold cathode fluorescent lamp deteriorates considerably in the period from the beginning of lighting (in the initial stage) to a lapse of 1,000 hours (the initial 1.000 hours), and the subsequent deterioration is slight. Considering this tendency, when the value of initial luminance is taken as 100%, in the case where the luminance after a lapse of 1,000 hours shows 80% or more of the initial luminance, the lamp is judged to have endurance. The test result showed that the lamp of Example had a value of 93%, proving that it has no problem in the endurance, and that the lamp of Comparative example had a value of 65%. Whereas the lamp of Comparative example developed gas leakage while it is being lit, the lamp of Example developed no gas leakage. In light of the above result, it is probable that a reason why the lamp of Example had endurance is that the constituting members from the lead wire to the glass tube were brought into sufficient intimate contact between them, so that the gas in the glass tube remained sufficiently. In addition, it appears that having excellent endurance, the lamp of Example has a long life.

Example described above can be modified as required without deviating from the main point of the present invention and is not limited to the above-described structure.

### INDUSTRIAL APPLICABILITY

The electrode member of the present invention can be suitably used as a constituting member of a cold cathode fluorescent lamp. The method of the present invention for producing an electrode member can be suitably used to produce the electrode member of the present invention. A cold cathode fluorescent lamp incorporating the electrode member of the present invention can be suitably used as light sources of various electric devices, such as a light source for a backlight of a liquid crystal display, a light source for a front light of a small-size display, a light source for illuminating a document in a copier, a scanner, or the like, and a light source for an eraser of a copier.

1. An electrode member for a cold cathode fluorescent lamp, the electrode member comprising an electrode portion and a lead portion connected to an end portion of the electrode portion; wherein:
(a) the lead portion is formed such that a part of its surface side or its entire surface side is composed of an iron-containing metal;
(b) the lead portion has an oxide film on a part of its surface or on its entire surface; and
(c) the oxide film contains 1% or more FeO in volume ratio.

2. (canceled)

3. The electrode member for a cold cathode fluorescent lamp as defined by claim 1, the electrode member further comprising a glass portion bonded to the periphery of the lead portion; wherein the lead portion has, on its surface, the oxide film at the portion covered by the glass portion.

4. A method of producing an electrode member for a cold cathode fluorescent lamp, the electrode member comprising an electrode portion and a lead portion connected to an end portion of the electrode portion;
the lead portion being formed such that a part of its surface side or its entire surface side is composed of an iron-containing metal;
the method comprising an oxide-film-forming step that forms an oxide film on the surface of the lead portion by heating the periphery of the lead portion;
wherein:
(a) the oxide-film-forming step comprises an oxidizing step and a nonoxidizing step;
(b) the oxidizing step forms the oxide film by heating the lead portion in an oxidizing atmosphere; and
(c) after the oxidizing step, the nonoxidizing step forms FeO in the oxide film by heating the lead portion in a nonoxidizing atmosphere.

5. The method of producing an electrode member for a cold cathode fluorescent lamp as defined by claim 4, the electrode member further comprising a glass portion bonded to the periphery of the lead portion;
the method further comprising a glass-portion-forming step that places a glass bead on the periphery of the lead portion on which the oxide film is formed and that heats the glass bead both to form a glass portion by deforming the glass bead and to bond the glass portion to the lead portion.

6. An electrode for a cold cathode fluorescent lamp, the electrode comprising the electrode member as defined by claim 1, wherein the electrode member further comprises a glass portion bonded to the periphery of the lead portion through the oxide film existing on the surface of the lead portion.

7. A cold-cathode fluorescent lamp, comprising the electrode as defined by claim 6.
